(19) United States
(12) Patent Application Publication
(10) Pub. No.: US 2014/0279329 A1
(43) Pub. Date: Sep. 18, 2014

(54) DEBT EXTINGUISHMENT RANKING MODEL

(71) Applicant: BERNALDO DANCEL, Columbia, MD (US)

(72) Inventor: BERNALDO DANCEL, Columbia, MD (US)

(21) Appl. No.: 14/043,218

(22) Filed: Oct. 1, 2013

Related U.S. Application Data
(60) Provisional application No. 61/789,286, filed on Mar. 15, 2013.

(51) Int. Cl. G06Q 40/02

(52) U.S. Cl. CPC G06Q 40/02
USPC 705/35

(57) ABSTRACT

System and method for debt-extinguishment includes one or more processors having at least one memory and an interface coupled to the Internet. The one or more processors are configured to store in the at least one memory a plurality of sub-models including at least two of (i) litigation likelihood sub-model; (ii) litigation severity sub-model; (iii) customer-ability-to-pay sub-model; (iv) offer-acceptance sub-model; and (v) next best offer sub-model. The one or more processors are also configured to receive from a debtor computer, through the Internet and said interface, at least one input containing information corresponding to a debt owed to at least one creditor. The one or more processors are further configured to calculate an offer amount, based on (i) a predetermined formula corresponding to said plurality of sub-models and the (ii) input containing information corresponding to a debt owed to at least one creditor.

This application claims the benefit of U.S. Patent Appln. No. 61/789,286, filed Mar. 15, 2013, the contents of which are incorporated herein by reference.

### BACKGROUND OF THE INVENTION

1. Field of the Invention

The present invention relates to a system, apparatus, and method for a Debt Extinguishment Ranking Model (DERM), which evaluates settlement offers on different debts within a household/customer by quantifying both tangible and intangible values. More preferably, the present invention relates to unique systems and processes to accurately assess the value of a particular settlement offer and facilitate optimal resolution of consumer debts.

2. Description of Related Art

There are a number of known debt settlement algorithms in use to structure debt payment schedules and steps. For example, Debt-Resolve, Inc. has an Internet portal where a debtor facing collection can go online and resolve past due debts without having to speak with anyone. Debt Resolve's U.S. Pat. Nos. 6,330,551; 6,850,918; 7,249,114; and 7,831,523 generally relate to a computerized system for automated dispute resolution through an Intranet website via the Internet. A series of demands is processed to satisfy a claim made by a claimant against a debtor, his/her insurer, etc. A series of offers to settle the claim is processed through at least one central processing unit including operation system software for controlling the central processing unit. Preferably the system also allows for the collection, processing, and dissemination of settlement data generated from the settlement through the operation of the system for use by sponsors and claimants in establishing the settlement value of future cases.

However, the known art still fails to achieve many desired traits in an effective debt settlement process such as anticipated litigation, settlement intelligence, a robust customer ability to pay model, etc. Additionally, the known prior art focuses on the transactional aspects of debt settlement, treating each debt settlement as an independent event and trying to inform and make such transaction as efficient as possible.

### SUMMARY OF THE INVENTION

The present invention differentiates from the prior art through the evaluation of all of a customer's unsecured debts and incorporates the above listed factors to arrive at an optimal extinguishment order for each debt. Through the consideration of these factors, the invention ensures that the debt extinguishment order is established holistically from a customer perspective.

The present invention also has secondary applications beyond establishing extinguishment priority, namely assisting consumers, creditors, and/or creditor negotiators with a tool to valuate a particular settlement offer relative to offers a customer would likely receive (based on empirical data) in connection with their other debts. Another application of the invention would be to use it to determine the “best” (or most valuable) settlement offer when faced with multiple offers competing for the same, limited available customer funds and to facilitate bidding by creditors on such available funds. Other applications involve using the invention to determine which debts of a consumer are most suitable for resolution through a debt management plan or through a debt settlement plan (or some combination thereof); and determining the next debt of a consumer that is most likely to be settled and on what terms.

It is an advantage of the present invention to overcome the problems of the related art and to provide a debt extinguishment ranking model whereby a plurality of sub-models (related to the likelihood of offer-acceptance success) may be combined in a way to produce the greatest likelihood of a successfully extinguishing all of the customer's debt.

According to a first aspect of the present invention, a novel combination of structure and/or steps is provided whereby a system for debt-extinguishment includes one or more processors having at least one memory and an interface coupled to the Internet. The one or more processors are configured to store in the at least one memory a plurality of sub-models including at least two of (i) litigation likelihood sub-model; (ii) litigation severity sub-model; (iii) customer-ability-to-pay sub-model; (iv) offer-acceptance sub-model; and (v) next best offer sub-model. The one or more processors are also configured to receive from a debtor computer, through the Internet and said interface, at least one input containing information corresponding to a debt owed to at least one creditor. The one or more processors are further configured to calculate an offer amount, based on (i) a predetermined formula corresponding to said plurality of sub-models and the (ii) input containing information corresponding to a debt owed to at least one creditor.

According to a second aspect of the present invention, a novel combination of structure and/or steps is provided whereby a computer-implemented method for debt-extinguishment, includes: (a) storing in at least one memory a plurality of sub-models including at least two of (i) litigation likelihood sub-model; (ii) litigation severity sub-model; (iii) customer-ability-to-pay sub-model; (iv) offer-acceptance sub-model; and (v) next best offer sub-model; (b) receiving from a debtor computer, through the Internet and an interface, at least one input containing information corresponding to a debt owed to at least one creditor; and (c) calculating, with at least one processor, an offer amount, based on (i) a predetermined formula corresponding to said plurality of sub-models and the (ii) input containing information corresponding to a debt owed to at least one creditor.

According to a third aspect of the present invention, a novel combination of features is provided whereby non-transitory computer-readable media for debt-extinguishment includes computer code which, when loaded into one or more computers cause said one or more computers to: (a) store in at least one memory a plurality of sub-models including at least two of (i) litigation likelihood sub-model; (ii) litigation severity sub-model; (iii) customer-ability-to-pay sub-model; (iv) offer-acceptance sub-model; and (v) next best offer sub-model; (b) receive from a debtor computer, through the Internet and an interface, at least one input containing information corresponding to a debt owed to at least one creditor; and (c) calculate an offer amount, based on (i) a predetermined formula corresponding to said plurality of sub-models and the (ii) input containing information corresponding to a debt owed to at least one creditor.

### BRIEF DESCRIPTION OF THE DRAWINGS

Exemplary embodiments of the presently preferred features of the present invention will now be described with reference to the accompanying drawings.

FIG. 1 is a block diagram of certain of the apparatus according to a preferred embodiment of the present invention.

FIG. 2 is a schematic functional block diagram of the overall processes carried out by the structure depicted in the FIG. 1 embodiment.

FIG. 3 is a schematic functional block diagram of the formula operations carried out in the DERM processing structure of the FIG. 1 embodiment.

FIG. 4 is an overall flowchart of the functions carried out in the debt extinguishment process flow of the FIG. 1 embodiment.

### DETAILED DESCRIPTION OF THE PRESENTLY PREFERRED EXEMPLARY EMBODIMENTS

### 1. Introduction

The present invention will now be described with respect to several embodiments in which debtor, creditor, and DERM processing structure communicate with one another over the Internet. However, the present invention may find applicability in other devices/systems, such as a wide area network, a local area network, of where any of the processing structures may be co-located with others such as, by way of example, the debtor processing structure is at the same location as the DERM processor and/or the same location as the creditor processing structure.

Briefly, the preferred embodiments of the present invention provide for a debtor providing inputs to the DERM structure regarding the debt, the creditor, etc. The DERM processing structure uses the debtor input, a plurality of stored information corresponding to sub-models, and at least one formula to provide a score corresponding to a debt-resolution offer likely to be accepted by that creditor for that particular debt.

For this disclosure, the following terms and definitions shall apply:

The term “processor” and “processing structure” as used herein means processing devices, apparatus, programs, circuits, components, systems, and subsystems, whether implemented in hardware, tangibly-embodied software or both, and whether or not programmable. The term “processor” as used herein includes, but is not limited to, one or more computers, personal computers, CPUs, ASICS, hardwired circuits, signal modifying devices and systems, devices, and machines for controlling systems, central processing units, programmable devices, and systems, field-programmable gate arrays, application-specific integrated circuits, systems on a chip, systems comprised of discrete elements and/or circuits, state machines, virtual machines, data processors, processing facilities, and combinations of any of the foregoing.

The terms “storage” and “data storage” and “memory” as used herein mean one or more data storage devices, apparatus, programs, circuits, components, systems, subsystems, locations, and storage media serving to retain data, whether on a temporary or permanent basis, and to provide such retained data. The terms “storage” and “data storage” as used herein include, but are not limited to, hard disks, solid state drives, flash memory, DRAM, RAM, ROM, tape cartridges, and any other medium capable of storing computer-readable data.

A “debtor” is an entity and/or one or more individuals that owe a monetary debt to another entity, the “creditor.” The debtor may be an individual, a firm, a government, a company or other legal person. When the creditor is a bank, the debtor is often referred to as a borrower. A “debtor” may also be referred to as a “customer” or “client”.

A “creditor” can be either a bank, collections agency, collections law firm, medical office, payday loan company, finance company, or a debt buyer/purchaser.

The term “concessions” means some change that a creditor is willing to make in connection with a debt relief plan that will allow a consumer to repay a particular debt on terms more favorable than the original, contracted terms. Concessions typically include reduced interest rates and may include stopped late charges (after several timely payments).

A “debt management plan” or “DMP” is a debt repayment plan that helps customers secure creditor concessions and consolidate their unsecured debts into one affordable monthly payment to eventually repay the full principal balance of their debts in five years or less. Under a DMP, consumers make one monthly payment to a debt relief provider and the debt relief provider distributes that payment among that customer's creditors each month. Creditors typically reduce interest rates and agree to accept the amount paid under a DMP for 3-5 years in order to receive full payment of principal.

A “debt settlement plan” or “DSP” is a plan where customers make monthly deposits into an escrow account in an amount that they can afford in order to accumulate funds to be used to pay back a portion of the principal balance of their unsecured debts. Customers suitable for a DSP have generally stopped paying some or all of their creditors and funds that are paid into escrow are used to make settlement offers for less than full principal balance, typically one creditor at a time. Settlements are often structured so that creditors receive a lump sum payment of somewhere between 50-60% of amount owed or pay a similar amount over a short duration (3-6 months).

### 2. The Structure of the Preferred Embodiments

With reference to FIG. 1, the debtor processing structure 100 preferably contains a bus 102 connecting together various modules such as processing structure (e.g., CPU) 104, memory 106, interfaces (e.g., modem, WiFi, etc.) 108, input-output structure (e.g., mouse, keyboard, stylus, etc.) 110, and GUI (e.g., LCD, LED, plasma monitor, etc.) 112. The debtor processing structure 100 may be a personal computer, a Pad, a smart phone, a PDA, a laptop, etc. The CPU 104 and memory 106 have store and process computer code which is used to carry out the numerous functions to be described more fully below. The debtor processing structure 100 communicated to the other processors through the Internet, by well-known means such as cable, fiber-optic, WiFi, etc.

In like fashion, the creditor processing structure 200 preferably contains a bus 202 connecting together the processing structure 204, the memory 206, interfaces 208, input-output structure 210, and GUI 212. And the DERM processing structure 310 preferably contains a bus 302 connecting together the processing structure 304, the memory 306, interfaces 308, input-output structure 310, and GUI 312.

### 3. The Functions of the Preferred Embodiments

FIG. 2 is a schematic functional block diagram of the overall processes carried out by the structure depicted in the FIG. 1 embodiment. The individual debtors 10 use the client web portal 12 on the debtor processing structure 100 to access web services/APIs (application programming interfaces) 14. The client portal 12 provides a Do-It-Yourself capability to allow the debtor/client, on their respective processing structures, to participate in the offer/counteroffer/acceptance/rejection functionality in the marketplace. The debtor will have the ability to input via a user interface all the debts he/she wants to negotiate settlements for as well as his/her financial budget. The system would provide recommended settlement rates and the debt extinguishment sequence based on the client specific financial situation, debt characteristics, and the creditors' historical settlement trends. At this point, the debtor can choose to submit one or more settlement offers to the creditors or engage in a settlement auction. In the first situation where the debtor chooses to submit settlement offers, once a creditor accepts the settlement offer all other offers will be removed since there would be no more escrow in the account for other settlements. The creditors will have the option to submit counteroffers in the event that they find the offer presented by the debtor isn't satisfactory. The counteroffers will in turn be presented back to the debtor who can choose to re-submit any counteroffer. If the debtor chooses to go with a settlement auction, all the debtor's known creditors will be informed and given the opportunity to submit their bids. The creditor with the highest bid that is above the reserve price (as determined by the Debt Extinguishment Index) at auction expiration would be awarded the settlement deal. The web services/APIs 14 allows third parties acting on behalf of the client to represent the clients' interests in the debt resolution process. Third parties could include credit collections agencies (CCAs), debt settlement companies, and client law firms. The APIs allow the third party to use their websites and/or internal systems and processing structures to participate directly in the marketplace. The preferred embodiments utilize such API's on respective processing structures to connect the Financial Fitness Center (FFC) (a proprietary customer relationship manager (CRM) application running on a processing structure that is used to on-board new clients seeking assistance with management of their debts via a DMP or DSP) and its other ‘client-side’ systems to the consumer marketplace.

Customer-side decision support 16 operating on debtor processing structure 100 allows the client to utilize data and logic derived from the marketplace to make better decisions in how they resolve their debts. Guidance on decisions about whether to select DMP for a given account, the best strategy given personal tolerance for risk/litigation, bidding options, and recommendations, etc. Examples of the information that would be provided by the customer-side decision support system are historical settlement terms accepted by the creditor based on a customer and debt specifics: settlement rate, maximum number of payments, minimum monthly payment amount, whether a payment needs to be made in the same month. If appropriate, for each of the settlement terms, the minimum, mean, median, and maximum would be provided. Tranche management 18 provides the ability to select a group of accounts based on certain criteria for the purpose of making offers and managing settlements on a group of accounts instead of individually. This functionality is more for settlement companies as it gives them the ability to create different portfolio of debts meeting different settlement criteria. For example, settlement companies could create a portfolio of debts belonging to a particular creditor that has sufficient escrow for a 50-60% settlement, over a period of 12 months and with each debt being over $3,000 to understand the potential and how this potential can change by altering the criteria used to create it. In essence, tranche management is a tool for settlement companies to use for scenario planning tool as well as to negotiate in bulk with creditors.

The creditor-side functions depicted of FIG. 2 are typically performed by the creditor processing structure 200. The users, creditors, collection agencies, debt buyers, and/or law firms 20 may use DebtConnect (see below) 22 and data exchanges/web services 24 to input information into decision support 26. DebtConnect 22 is the primary web-based user interface for creditor interaction with the market clearing technology. Data exchange/web services 24 is the electronic, web-service interface for creditor interaction with the market clearing technology. Ultimately, everything a user can do through DebtConnect should be available through the data exchange and web services. Creditor decision support 26 provides the creditor with data and information about past market clearing activity to support their bidding/yield management strategy. Examples of information that would be provided by the creditor decision support system include settlement statistics on accepted deals over the last 90 and 180 days for a given debt and consumer characteristics: historical settlement rate, maximum number of payments, minimum monthly payment amount, as well as acceptance rate by different settlement rate ranges. Tranche Management 28 provides the ability to select a group of accounts based on certain criteria for the purpose of making offers and managing settlements on a group of accounts instead of individually. This functionality lets the creditors “slice-and-dice” and re-organize the debt portfolio. Important components include the ability to understand the relationship between price (settlement rate) and volume across the spectrum of the creditor's accounts. This lets the creditor run hypotheticals of how much debt they can deal with.

DebtConnect is a web portal for creditors and other parties to identify and facilitate debt settlements and manage settlement terms. It provides creditors with functionalities to make the settlement process with participating debt settlement companies or debtors more efficient. The functionalities are as follows:
DebtTracker—this functionality allows creditors to share information of their customers that are available for settlement (including requested settlement amount) with debt settlement companies so that the different parties can identify common customers and begin the settlement process. This process can be initiated two ways, either by creditors or by settlement companies. In the first case, a creditor uploads a file of their customers including their requested settlement amount into the system to have it matched against clients from participating settlement companies. Settlement companies for the matched accounts will be informed and they can review the requested amounts and determine if they want to submit 1) the “requested offer” 2) a counteroffer, or 3) not submit if there is insufficient escrow in the client's account. Alternatively, the settlement companies can initiate the process by uploading a file of all their clients which would be made available for creditors to download and match with their database. In this situation, a creditor would download the settlement companies' client lists, conduct the matching in their own system and just upload the matches back to DebtConnect. Once again, settlement companies with matched accounts will be notified and they can choose one of the three actions described above.
Creditor Portal—this is the online settlement activation portal that allows creditors to review, approve, and activate settlement offers submitted for their consideration.
SmartOffer—this functionality allows creditors to provide settlement rules/instructions to debt settlement companies for the purpose of establishing customized settlement terms. Debts that are matched via DebtTracker will be processed per the processing instruction and if qualified, be submitted onto the Creditor Portal. The creditors can also provide their requested settlement amount (or parameters), at the debt level, to the system when they upload the matched debts (e.g. 45% settlement over 6 payment terms with at least $25 for each payment except the last—the first payment must be delivered before the end of the month). For settlement companies that participate in SmartOffer, the system will automatically review all their matched debts and generate an offer for the creditor to approve if both sets of conditions are met: 1) there is sufficient escrow in the client's account to meet the requested settlement parameters, and 2) the settlement parameters requested are within the threshold previously defined by the settlement companies.
E-payment Engine—this functionality allows creditors to set up electronic payments where they would receive settlement payments via ACH.

Also in FIG. 2, the market-clearing functions typically carried out in the DERM processing structure 310 will now be described. The market-clearing functions 30 include account matching processing 32 which allows for the dynamic matching and tracking of client/debtor accounts with creditor accounts. For example, the settlement companies will upload their list of active clients and their enrolled debts into the system with unique information as such as SSN and/or account numbers. Likewise, the creditor could do the same with customers they would like to find a match for. The market-clearing function would search the entire DebtConnect system and identify the matched accounts through combinations of the different unique identifiers—there will be three different outcomes from the matching exercise: 1) matched customers but with no matching debts, 2) both customers and debts are matched, or 3) the non-matched category. Data management 34 stores, manipulates, and prepares data for use by the participants in the marketplace. Similar to a data warehouse, this process makes sure that all data is available when it is needed to make efficient decisions. For example, previous creditor offers may need to be translated to a single offer coefficient so that they can be compared and target settlement rates can be calculated for future transactions. A rules/logic engine 36 is the process that allows flexible logical and mathematical rules as described below to be used to orchestrate and make decisions in the marketplace. An example of the rule would be to utilize Debt Extinguishment Index (DEI, an output of DERM processor to be described below) that is calculated for every debt enrolled by a customer and normalize the most likely offer for each debt against the most valuable offer (by setting the DEI for every enrolled debt for a client to the highest value DEI for the client—the offer on this debt would also be the most valuable offer—and solving for the lowest settlement rate needed to achieve this value). This would have the effect of making all offers equivalent. The rules engine will then solve for settlement rate and terms needed to achieve the normalized offers and assign creditor acceptance likelihood for each such offer. For example, a client has two debts A and B. Based on historical settlement data collected on the creditor for Debt A, the estimated settlement offer is 43% and 3 payments and this offer has a DEI of 0.90. Similarly for Debt B, the estimated settlement offer is 35% and 4 payments and a DEI of 0.84. To normalize the offers, set the DEI for Debt B to 0.90 and the DERM algorithm will solve for the lowest settlement rate needed for Debt B to get to a DEI value of 0.90. If the new settlement rate to get Debt B to a DEI value of 0.90 is 33%, the process has essentially normalized the offers on Debt A and Debt B and the customer should be indifferent to either offer. The combination of creditor acceptance likelihood and creditor success rate by channel of negotiation would then be used to assign the debts to the proper channel. Expanding on the example described above, Debt A has a creditor acceptance likelihood of 80% while Debt B has a creditor acceptance likelihood of 30%. If both creditors will only conduct negotiations via the phone, given that this is an expensive negotiations channel, only settlement negotiations with high creditor acceptance likelihood will be served up. If the threshold is set at 60% or higher, then only Debt A will be served up for creditor negotiators to conduct settlement negotiations via an outbound call. Debt B will still be available for settlement but only if the creditor calls in for settlement negotiation.

The debt extinguishment model 37 is a group of mathematical models illustrated in FIG. 3 that will be used to determine numerical coefficients used in the market clearing and decision support functions of the marketplace. This determines the value of the debt and a logical resolution. This is business intelligence. The auction management 38 are the processes used to resolve competing offers in an efficient manner. Methods will include a combination of mathematical optimization and auction/exchange techniques as described below. The system would allow for different auction techniques to be used to decide the ultimate winner of the settlement auctions. A few of the popular auction techniques include English, Dutch, Sealed First-Price and Vickrey. Contract management 39 records and maintains a historical record of the transactions completed in the marketplace.

The DERM processing structure 310 carries out an algorithm that evaluates settlement offers on different debts within a household/customer by quantifying both tangible and intangible values, as discussed below. The DERM is an optimization model that incorporates an expandable set of input variables to calculate the Debt Extinguishment Index (DEI). DERM values and ranks all available debts for a particular client using the company's historical settlement experience and customer preference to determine the debt extinguishment sequence. Two output variables of DERM are: the Debt Extinguishment Index; and the Settlement Rate (FIG. 3). The tangible values DERM quantifies include settlement savings (after DERM processing fees) to customers; litigation cost; breakage cost. Breakage cost is the cost to a customer if a settlement deal is broken due to a missed payment. For example, if a customer made six consecutive payments into an eight-payment deal, the deal would be nullified at month seven if the customer missed payment seven. The cost of breaking the deal would be that every dollar paid to the creditor in the first six months would only be valued at one dollar instead of two dollars (assuming 50% settlement rate) and in this instance, the value the customer derived from the creditor for doing this settlement would be halved.

The intangible values DERM quantifies include customer utility (customer preference). Some customers may prefer getting a deal with the lowest possible settlement rate and may be willing to wait for that offer. For others, being able to see progress is more important and thus, getting a deal done on a small debt and at an average settlement rate would be more desirable for them. Customers will be given the ability to rank their preference and DERM will incorporate this preference into the eventual score—Debt Extinguishment Index); and creditor leniency (some creditors will allow customers to make up missed payments as long as they did not occur in consecutive months, while others will immediately nullify the deal). The creditor leniency variable would be used to identify these two types of creditors and the DERM calculation would give the former group a more favorable weighting and consequently, offers from the “lenient” creditors will be scored higher. The output of the DERM processor, Debt Extinguishment Index, is a score (numeric value from 0.0000 to +$999,999.0000) for each debt that the customer enrolls with the DERM processor. This score is derived from a collection of sub-models (to be described in greater detail below) that attempt to measure the value of settling the debt based on the debtor's historical settlement history with the creditor.

The following are factors or sub-models which the DERM processing structure 310 uses to calculate the score (FIG. 3). The list is illustrative and may include more or fewer factors, or any combination thereof
1. Litigation Model, which predicts, at the current debt level, the likelihood of the debt being litigated by the creditor (and losing), based on factors such as creditor litigation behavior, size of debt, age of delinquency, etc. This model utilizes both client specific information such as income and expenses as well as debt specific information such as the creditor, age of delinquency and preplan balance to determine the likelihood of litigation. Every debt in the system scored by the litigation model will be assigned a value between 0 and 1. The value is the estimated probability a debt would be litigated.
2. Litigation Severity Model, which predicts, at the current debt level, the severity of the litigation outcome in the event of a debtor-adverse outcome. This model utilizes factors such as state of residence to determine wage garnishment and statute of limitation information (as advised by appropriate legal counsel) to estimate the potential impact of litigation should an adverse outcome occur. Every debt in the system that is scored using the litigation severity model will be assigned a value of either 0 and 1 where 0 indicates no impact and 1 indicates an impact should there be an adverse decision.
3. Customer's Ability to Pay Model, which determines customer's ability to fully complete the entire payment terms (consequently drive “true” value that is generated for the customer), in, e.g., the next 3, 6, 12, 18, and 24 months. This model is at the customer level and takes into account factors such customer tenure, prior payment history, payment methods and contact history to estimate a customer's likelihood to miss a payment over any time period. Every debt in the system that is scored by the Customer's Ability to Pay model will be assigned a value of either 0 and 1 for each time period which represents a customer's probability of missing the payment in the stated time period.
4. Settlement Intelligence Model, which determines offer/acceptance likelihood for a settlement offer based on observed historical creditor behavior and debt characteristics. This model takes into account creditor specific information such as settlement rates and terms that were previously accepted by creditors as well as debt specific characteristics such as age of delinquency and current debt balance. Every debt in the system that is scored by the Settlement Intelligence Model will have a settlement rate and settlement terms that has a high probability of being accepted by the creditor.
5. Customer Utility Model, which factors-in customer preferences such as extinguishing larger deals first, or the most efficient use of the debtor's money, fastest extinguishment, litigation prevention, etc. The output of this model will be percentages (must total 100%) for each of the different factors based on the customer risk aversion or settlement preference. This would then be used to assign the Model weight shown in FIG. 3. For example, a customer who is very risk averse to litigation could assign 80% (out of the 100%) as the Model weight for the Litigation model and that would have the effect of directing a settlement towards a debt that has a high probability of being litigated so as to avert litigation even though the settlement terms are less attractive than other potential settlements.
6. Other Creditor Specific Tendencies Model to factor-in, which may include one or more of: Leniency on missed payments; Litigation concessions; Low cost creditor (enrolled in low cost transaction channel). This model captures a count of the different concessions provided by each creditor and its output would be applied as Model Weights. This serves as a way for the DERM algorithm to factor in and rank creditors based on the accommodative nature of their policies to debtors.
7. Next Best Offer Model, which predicts, at the current debt level, the likelihood of getting more favorable terms as well as an estimate of the amount of time needed to get it. This model takes into account factors such as the current creditor for a debt and historical migration trends (also known as debt lineage) as well as debt level characteristics such as age of delinquency and current debt level. The output of this model is the probability of creditor change and the new settlement terms accepted by the new creditor. This information will allow the DERM algorithm to make tradeoff decision on settling a debt now versus waiting to settle with the future holder of the debt.
8. Other Customizable Models based on individual Debtors and Creditors.

FIG. 3 is a schematic functional block diagram of the formula operations carried out in the DERM processing structure of the FIG. 1 embodiment. The DERM processing structure 310 stores a main-engine model 31 which carries out the below calculations to produce the settlement score. Each of the sub-models will be scored independently by running a script, which could either be via a nightly process or triggered based on the occurrence of a pre-defined set of business events, and will pull the data directly from the different database tables. For example, the output of the litigation model for each debt would be the probability of such debt being litigated. To further elaborate, if the entire system consists of 2 customers, A and B, where Customer A has 3 debts A1, A2 and A3 and customer B has 2 debts B1 and B2. Upon running the litigation model, all the debts in the system, A1, A2, A3, B1 and B2, will each be assigned a number between 0 and 1 representing it likelihood to be litigated. The output from the different sub-models will then be used in the DERM calculation to create the Debt Extinguishment Index, preferably using at least two of: Litigation Model 32a; Litigation Severity Model 32b; Customer's Ability to Pay Model 32c; Offer/Acceptance Model 32d; Next Best Offer Model 32e; and any selectable TBD Model 32f. The weighted amount for each selected model is then chosen; in FIG. 3, the respective weights are 15%, 10%, 25%, 35%, 10%, and 5%, although any amounts 1-99% may be chosen for the preferred at least two models.

After the main engine model 31 calculates the score, possible uses for that score include: Good Faith Estimate (see below) 33a to provide customer with the debt extinguishment sequence and timing; Determine (rank-order) Debt Extinguishment Sequence 33b for any particular customer at any point in time across any channel for negotiation purposes; and Determine the appropriate settlement rate (as described in [0030] above) needed to move a debt to the “best-debt-to-settle” status (both for direct negotiation and for establishing counter-offers), Settle-it-Now Settlement Rate Estimator (see below) 33c. Practical uses for DERM include: Prioritize which debt to extinguish first for a customer; Assist customers with a tool to valuate multiple settlement offers; Provide creditors with a tool to understand how to make their settlement offer competitive (or become the top offer); and ultimately, in the eventual marketplace, this will be the algorithm that the customer (or debt settlement companies) will use to arbitrate which “settlement offer” to accept.

The Good Faith Estimate provides customers with a comprehensive view, across their DMP and/or DSP, the ORDER of how debts would be extinguished (Debt Extinguishment Sequence) and WHEN all the enrolled debts are expected to be extinguished. This in essence provides customers with a roadmap of the expected debt extinguishment process. When called upon, this application will extract information such as the status of the enrolled debts, the Debt Extinguishment Index and settlement terms (for debts in the DSP program) and the expected amortization schedule (for debts in a DMP) to make this determination.

Settle-it-Now Settlement Rate Estimator provides users of this application the ability to take any settlement offer and normalize it against the best settlement offer the customer is likely to receive. The normalization process has the effect of making the Debt Extinguishment Index for the normalized offer equal to that of the best offer—making both offers equally valuable. Using this tool, the debtor or representatives for a debtor will be able to inform his/her creditors during the negotiations process what a settlement offer needs to be to make it the most valuable settlement offer—so that the deal can be consummated.

Main module 31 outputs will be utilized to inform debt settlement activities relative to the specific processing context. FFC and internet client origination (ICO) (i.e., customer-facing sales) will utilize 31 outputs to establish the optimal baseline debt profile for the customer, and will establish the initial strategy for extinguishing the customer's debts. Once a customer has been established on a plan, outputs 35 will be utilized to inform the customer of upcoming settlements, and to allow client servicing channels to adjust the debt profile as the customer's circumstances dictate. Finally, outputs 35 will inform the settlement channels (i.e., creditor negotiators, consumer marketplace) relative to the timing and structure of settlements.

Additional embodiments could include: (1) a system/process that uses DERM in combination with other systems or processes in order to evaluate a customer's debts, creditors, and income in order to determine if a customer is most suited for participation in a DMP or DSP; and/or a division of debts in which some debts are determined most suitable for inclusion in a DMP while others are determined most suitable for inclusion in a DSP; (2) a system/process that uses DERM in combination with other systems or processes in order to facilitate bidding by creditors on potential customer settlement funds; whereby a customer's available funds are made known to a pool of creditors and creditors bid (through an auction process described above) on those funds by proposing settlement offers; and (3) a system/process that uses DERM in combination with other systems or processes in order to predict the next likely settlements and particular settlement terms and amounts for a customer as each debt is settled.

With reference to the flowchart of FIG. 4, two example scenarios utilizing features of the preferred embodiments will now be described.

### Example #1

### Non Auction Mode

Creditor #1 (42) uploads a file containing information on its debtor(s) 44 (includes requested settlement details) to the DebtConnect Portal via Web Services/APIs 14. This file will be picked up by Account Matching 32 to identify the number of debtors available for settlement on the DebtConnect Portal. Assuming there are X matches (common account) at 46, Data Management 34 will extract the input variables needed for Debt Extinguishment Model 37 to calculate the Debt Extinguishment Index for the X debtors; (If no common account at step 46, the process ends at step 47A). The Rules Engine 36 then evaluates the requested offer (from Creditor #1) against the most likely offer for each debt enrolled by the customer. If the requested offer is the best offer, and there are sufficient funds in the customer escrow account to complete the deal, a formal settlement offer will be made available to Creditor #1 via Auction Management 38. At this time, Creditor #1 will have the ability to activate/accept this settlement offer and a copy of the transaction detail will be captured and stored in Contract Management 39. If however, the requested offer is not the best offer, Auction Management would display the current position of the requested offer and Creditor #1 will have the ability to improve the position of the requested offer (if desired) by lowering the settlement amount requested.

### Example #2

### Auction mode

Two creditors, Creditor #1 and Creditor #2 (43), each upload a file containing information on their respective debtors (including requested settlement details) to the DebtConnect Portal via Web Services/APIs 14. These files will go through Account Matching 32 to identify the number of debts that are available for settlement purposes on the Portal. Assuming there are Y common debtors (Yes in step 46), each having at least one debt with Creditor #1, one with Creditor #2. Data Management 34 will extract the input variables for the Debt Extinguishment Model 37 to calculate Debt Extinguishment Index on all the debts for the Y debtors. The Rules Engine 36 would then evaluate the requested offers (from both Creditor #1 and #2) against the most likely offers for each customer. Through the creditor view in Auction Management 38, creditors will be able to see their own debtors and the ranking of their requested offers. The creditor will have the ability to increase the bid (steps 47B and 48), at the debtor level, by reducing the requested amount (if appropriate) to improve the ranking of its offer. The creditor may accept the deal at step 50, if not, the process returns to step 38. At auction expiration (step 51), the creditor whose requested offer is the best offer will receive notification that his/her offer is the winning offer and a digital copy of the transaction detail will be captured and stored in Contract Management 39.

### Example #3

### Debt Settlement Via Inbound Creditor Call Process

Creditor #1 calls a creditor negotiator at a debt settlement company to negotiate a settlement. The creditor negotiator will input the creditor's offer into the Settle-it-Now Settlement Rate calculator and determine if it is the most valuable offer and if there are sufficient funds in the customer escrow account to complete the deal. If the offer is not the most valuable offer, the creditor negotiator will inform Creditor #1 the settlement offer he/she needs to complete the deal (using the output from the Settle-it-Now Settlement Rate calculator). If an agreement is reached, the creditor negotiator will submit the deal via the Creditor Portal for the creditor to review and approve the settlement offer online A copy of the transaction detail will then be captured and stored in Contract Management 39.

### Example #4

### Debt Settlement Via Outbound Creditor Call Process

Each night, all enrolled DSP debts are run through Data Management 34 and the Debt Extinguishment Model 37 to calculate their Debt Extinguishment Index. The Rules/Logic engine 36 will normalize all likely offers against the most valuable offer for each customer/debtor—essentially making each offer the most valuable offer. The normalized offers will have different creditor acceptance likelihood and only offers that are above the creditor acceptance likelihood threshold (customized by participating debt settlement companies) are included in the outbound creditor call list—participating debt settlement companies will only receive their own debts in the outbound creditor call list. This list can be loaded into each participating debt settlement company's respective phone dialers for outbound calling. After the creditor negotiator contacts a creditor and is able to confirm the common debts, he/she can use the normalized offer as the basis for the negotiation. If an agreement is reached, the creditor negotiator will submit the deal via the Creditor Portal for the creditor to review and approve the settlement offer online. A copy of the transaction detail will then be captured and stored in Contract Management 39.

### 4. Conclusion

The individual components shown in outline or designated by blocks in the attached Drawings are all well-known in the debt settlement arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patents and patent applications discussed above are hereby incorporated by reference into the Detailed Description of the Preferred Embodiments.

What is claimed is:

1. Apparatus for debt-extinguishment, comprising;
one or more processors having at least one memory and an interface coupled to the Internet, said one or more processors being configured to:
store in said at least one memory a plurality of sub-models including at least two of (i) litigation likelihood sub-model; (ii) litigation severity sub-model; (iii) customer-ability-to-pay sub-model; (iv) offer-acceptance sub-model; and (v) next best offer sub-model;
receive from a debtor computer, through the Internet and said interface, at least one input containing information corresponding to a debt owed by the debtor to at least one creditor;
calculate a settlement offer amount, based on (i) a predetermined formula corresponding to said plurality of sub-models, and the (ii) input containing information corresponding to a debt owed by the debtor to the at least one creditor; and
communicate the settlement offer amount to the debtor computer and to at least one computer of the at least one creditor, the settlement offer amount being such that if accepted by the debtor and the at least one creditor, the debt will be extinguished.

2. The apparatus according to claim 1, wherein the one or more processors calculates the settlement offer amount based on the predetermined formula:
litigation likelihood sub-model times from substantially 5-25 percent weight;
litigation severity sub-model times from substantially 1-20 percent weight;
customer-ability-to-pay sub-model times from substantially 15-35 percent weight;
offer-acceptance sub-model times from substantially 25-45 percent weight; and
next best offer sub-model times from substantially 1-20 percent weight.

3. The apparatus according to claim 1, wherein the one or more processors calculates the settlement offer amount based on input containing information corresponding to plural debts owed by the debtor to respective plural creditors.

4. The apparatus according to claim 3, wherein the one or more processors provides a schedule of debt extinguishment for the plural debts.

5. The apparatus according to claim 1, wherein the one or more processors is configured to receive through the Internet and said interface at least one of (i) a settlement counteroffer from the debtor computer, and (ii) a settlement counteroffer from the at least one computer of the at least one creditor.

6. The apparatus according to claim 1, wherein the one or more processors is configured to calculate a settlement rate.

7. A computer-implemented method for debt-extinguishment, comprising;
storing in at least one memory a plurality of sub-models including at least two of (i) litigation likelihood sub-model; (ii) litigation severity sub-model; (iii) customer-ability-to-pay sub-model; (iv) offer-acceptance sub-model; and (v) next nest offer sub-model;
using at least one processor to receive from a debtor computer, through the Internet and an interface, at least one input containing information corresponding to a debt owed by a debtor to at least one creditor;
using the at least one processor to calculate a settlement offer amount, based on (i) a predetermined formula corresponding to said plurality of sub-models and the (ii) input containing information corresponding to a debt owed by the debtor to at least one creditor; and
using the at least one processor to communicate the settlement offer to the debtor computer and to at least one computer of the at least one creditor, the settlement offer amount being such that if accepted by the debtor and the at least one creditor, the debt will be extinguished.

8. The method according to claim 7, wherein the one or more processors calculates the settlement offer amount based on the predetermined formula:
litigation likelihood sub-model times from substantially 5-25 percent weight;
litigation severity sub-model times from substantially 1-20 percent weight;
customer-ability-to-pay sub-model times from substantially 15-35 percent weight;
offer-acceptance sub-model times from substantially 25-45 percent weight; and
next best offer sub-model times from substantially 1-20 percent weight.

9. The method according to claim 7, wherein the one or more processors calculates the settlement offer amount based on input containing information corresponding to plural debts owed by the debtor to respective plural creditors.

10. The method according to claim 9, wherein the one or more processors provides a schedule of debt extinguishment for the plural debts.

11. The method according to claim 7, wherein the one or more processors receives through the Internet and said interface at least one of (i) a settlement counteroffer from the debtor computer, and (ii) a settlement counteroffer from the at least one computer of the at least one creditor.

12. The method according to claim 7, wherein the one or more processors calculates a settlement rate.

13. The method according to claim 7, wherein the one or more processors calculates a debt extinguishment index.

14. Non-transitory computer-readable media for debt-extinguishment, comprising computer code which, when loaded into one or more processors causes said one or more processors to:
store in at least one memory a plurality of sub-models including at least two of (i) litigation likelihood sub-model; (ii) litigation severity sub-model; (iii) customer-ability-to-pay sub-model; (iv) offer-acceptance sub-model; and (v) next nest offer sub-model;
receive from a debtor computer, through the Internet and an interface, at least one input containing information corresponding to a debt owed by a debtor to at least one creditor;
calculate a settlement offer amount, based on (i) a predetermined formula corresponding to said plurality of sub-models and the (ii) input containing information corresponding to a debt owed to at least one creditor; and
communicate the settlement offer amount to the debtor computer and to at least one computer of the at least one creditor, the settlement offer amount being such that if accepted by the debtor and the at least one creditor, the debt will be extinguished.

15. The non-transitory computer-readable media according to claim 14, wherein the computer code, when loaded into the one or more processors causes said one or more processors to calculate the settlement offer amount based on the predetermined formula:
litigation likelihood sub-model times from substantially 5-25 percent weight;
litigation severity sub-model times from substantially 1-20 percent weight;
customer-ability-to-pay sub-model times from substantially 15-35 percent weight;
offer-acceptance sub-model times from substantially 25-45 percent weight; and
next best offer sub-model times from substantially 1-20 percent weight.

16. The non-transitory computer-readable media according to claim 14, wherein the computer code, when loaded into the one or more processors causes said one or more processors to calculate the settlement offer amount based on input containing information corresponding to plural debts owed by the debtor to respective plural creditors.

17. The non-transitory computer-readable media according to claim 16, wherein the computer code, when loaded into the one or more processors causes said one or more processors to provide a schedule of debt extinguishment for the plural debts.

18. The non-transitory computer-readable media according to claim 14, wherein the computer code, when loaded into the one or more processors causes said one or more processors to receive through the Internet and said interface at least one of (i) a settlement counteroffer from the debtor computer, and (ii) a settlement counteroffer from the at least one computer of the at least one creditor.

19. The non-transitory computer-readable media according to claim 14, wherein the computer code, when loaded into the one or more processors causes said one or more processors to calculate a settlement rate.

20. The non-transitory computer-readable media according to claim 14, wherein the computer code, when loaded into the one or more processors causes said one or more processors to calculate a debt extinguishment index.
